(19) United States
(12) Patent Application Publication
(10) Pub. No.: US 2025/0298189 A1
(43) Pub. Date: Sep. 25, 2025

(54) METHOD AND EQUIPMENT FOR CONNECTING OPTICAL FIBERS

(71) Applicant: NIPPON TELEGRAPH AND TELEPHONE CORPORATION, Tokyo (JP)

(72) Inventor: Hidenobu HIROTA, Musashino-shi, Tokyo (JP)

(73) Assignee: NIPPON TELEGRAPH AND TELEPHONE CORPORATION, Tokyo (JP)

(21) Appl. No.: 18/863,603

(22) PCT Filed: May 19, 2022
(86) PCT No.: PCT/JP2022/020840

§ 371 Date: Nov. 6, 2024

(51) Int. Cl. G02B 6/25

(52) U.S. Cl. CPC G02B 6/25

(57) ABSTRACT

An object of the present disclosure is to shorten the amount of time communication stops in an optical fiber switchover work.

The present disclosure is a device and method for connecting optical fibers, the method connecting two optical fibers in which claddings at tips thereof are exposed, and comprising: bending a cladding of a first optical fiber; arranging a cladding of a second optical fiber on a straight line when the cladding of the first optical fiber is arranged linearly, in such a manner that an end of the cladding of the second optical fiber faces the first optical fiber; cutting the curved portion of the first optical fiber to arrange the first optical fiber and the second optical fiber on the straight line; and connecting an end face of the cladding of the first optical fiber and an end face of the cladding of the second optical fiber.

### TECHNICAL FIELD

The present disclosure relates to a technique for switching over connection of optical fibers in an optical communication network.

### BACKGROUND ART

In the optical access network, services of the Internet and telephone are provided to users. When the equipment constituting the optical access network is replaced, the switchover work of the optical fiber is performed from the equipment originally used to the new equipment. Although the optical fiber of the transfer source is used for communication, since the optical fiber is cut and fusion splicing or the like is performed in the switchover work of the optical fiber (see, for example, NPL 2), the communication is stopped during the work.

### CITATION LIST

### Non Patent Literature

[NPL 1] Institute of Electronics, Information and Communication Engineers “Knowledge Base,” Group 5, Part 2, Chapter 3, p. 1 to 5, https://ieice-hbkb.org/files/ad_base/view_pdf.html?p=/files/05/05gun_02hen_0 3.pdf #page=2
[NPL 2] Tomohiro Konuma, Akito Nishimura, Shoichiro Matsuo, and Kuniharu Himeno, “Basics and Advances on Splicing Technologies of Optical Fibers for Telecommunications,” Laser Research, 2012, Vol. 40, No. 6, p. 435

### SUMMARY OF INVENTION

### Technical Problem

An object of the present disclosure is to shorten the amount of time communication stops in an optical fiber switchover work.

### Solution to Problem

A device for connecting an optical fiber according to the present disclosure is a device for connecting two optical fibers, the device being configured to:
fix one end of an exposed cladding of a first optical fiber in which a part of a cladding in a longitudinal direction is exposed;
bend the exposed cladding of the first optical fiber; arrange an exposed cladding of a second optical fiber on a straight line when the exposed cladding of the first optical fiber is arranged linearly, in such a manner that an end face of the exposed cladding of the second optical fiber faces the first optical fiber;
cut the curved portion of the first optical fiber to arrange the first optical fiber and the second optical fiber on the straight line; and
connect an end face of the exposed cladding of the first optical fiber and the end face of the exposed cladding of the second optical fiber.

A method for connecting an optical fiber according to the present disclosure is
a method for connecting two optical fibers, the method comprising:
exposing a part of a cladding in a longitudinal direction of a first optical fiber;
exposing a cladding of a tip of a second optical fiber; bending the exposed cladding of the first optical fiber; arranging an exposed cladding of the second optical fiber on a straight line when an exposed cladding of the first optical fiber is arranged linearly, in such a manner that an end face of the exposed cladding of the second optical fiber faces the first optical fiber;
cutting the curved portion of the first optical fiber to arrange the exposed claddings of the first optical fiber and the second optical fiber on the straight line; and connecting an end face of the exposed cladding of the first optical fiber and the end face of the exposed cladding of the second optical fiber.

In the present disclosure, the claddings are made of glass, and a surface of an exposed cladding of the first optical fiber is scratched to cut the curved portion of the first optical fiber, and at the same time, the curved portion is released to be linear, and the end face of the exposed cladding of the first optical fiber and the end face of the exposed cladding of the second optical fiber may be arranged facing each other on the straight line.

In the present disclosure, when arranging the exposed cladding of the second optical fiber, the exposed cladding of the second optical fiber may be arranged in such a manner that the distance between the position on the straight line where the first optical fiber is cut and the position on the straight line where the end face of the exposed cladding of the second optical fiber is arranged becomes short.

In the present disclosure, the claddings are made of glass, and after the curved portion of the first optical fiber is cut to arrange the first optical fiber and the second optical fiber on the straight line, and before fusion splicing of the end face of the cladding of the first optical fiber and the end face of the cladding of the second optical fiber is performed, communication may be started. In this case, communication may be maintained during the fusion splicing after the fusion splicing is started.

The foregoing disclosures can be combined as much as possible.

### Advantageous Effects of Invention

The present disclosure can shorten the amount of time communication stops in an optical fiber switchover work.

### BRIEF DESCRIPTION OF DRAWINGS

FIG. 1 shows an example of a configuration of an optical access network.

FIG. 2A shows an example of a structure of a tape fiber.

FIG. 2B shows an example of a structure of an optical fiber.

FIG. 3 shows an example of an optical fiber switchover method according to the present disclosure.

FIG. 4 shows an example of an optical fiber cutting method.

FIG. 5 shows an example of a method of connecting optical fibers using fusion.

FIG. 6 is an explanatory diagram of a principle of focus of the present disclosure.

FIG. 7 shows an example of an optical fiber switchover method of the present disclosure devised.

FIG. 8 is an explanatory diagram of communications between optical fibers having a gap.

FIG. 9 is an explanatory diagram of the effects of the present disclosure.

FIG. 10 shows a configuration of an optical fiber connection device of the present disclosure.

FIG. 11 shows an example of a V-groove for holding a glass portion in a first holding member.

FIG. 12 shows an example of a usage of the optical fiber connection device.

FIG. 13 shows an example of a configuration for cutting the glass portion in the first holding member.

FIG. 14 shows an example of a configuration comprising a straight portion in the first holding member.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

### System Configuration

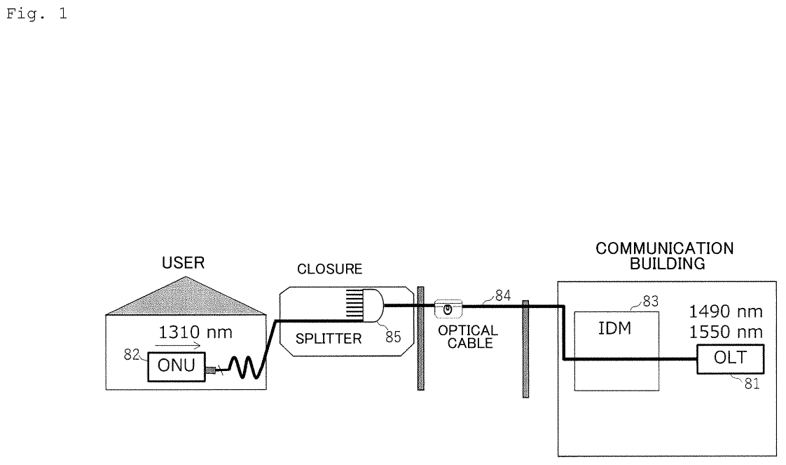

FIG. 1 shows a configuration example of an optical access network. An optical subscriber line termination device (Optical Line Terminal: OLT) 81, which is a communication device, is installed in a communication building, and an optical subscriber line network device (Optical Network Unit: ONU) 82 is installed in a user's home. The OLT 81 and the ONU 82 are connected by using an IDM 83, an optical cable 84, an optical splitter 85, and so on. By outputting wavelengths of 1490 nm and 1550 nm from the OLT 81 side and a wavelength of 1310 nm from the ONU 82 side as communication light, the OLT 81 and the ONU 82 recognize each other and provide high-speed broadband services such as the Internet and the telephone to the users. The optical cable 84 includes a tape fiber.

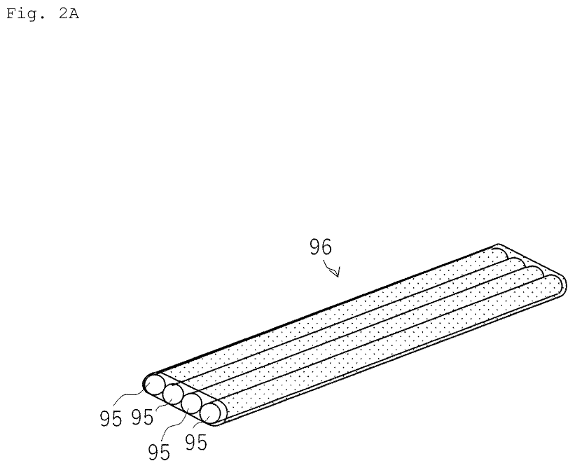

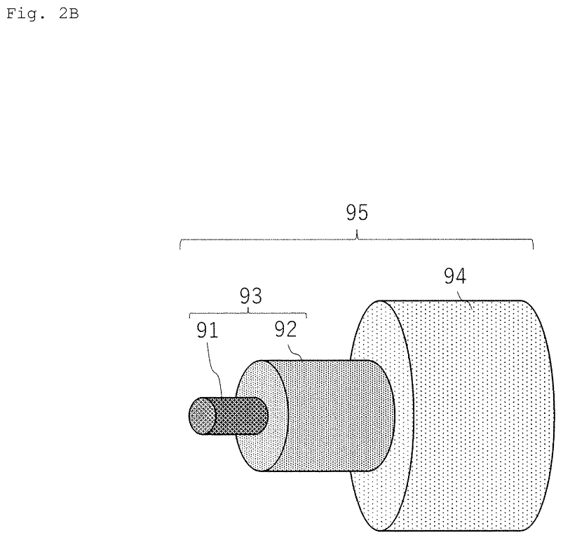

FIG. 2A shows a configuration example of a tape fiber (see, for example, NPL 1). A tape fiber 96 is a bundle of a plurality of optical fibers 95. As shown in FIG. 2B, the optical fiber 95 comprises a core 91, a cladding 92, and a coating 94. The communication light propagates through the core 91. A plurality of optical fibers 95, such as four or eight optical fibers 95, bundled in a planar state are referred to as the tape fiber 96. The core 91 and the cladding 92 may be made of any material, but the present embodiment shows an example in which the core 91 and the cladding 92 are made of glass. Hereinafter, a portion made of glass including the core 91 and the cladding 92 is referred to as a glass portion 93.

For communications using the optical fiber 95, a device must be installed on both ends of the optical fiber 95. An OLT 91 is installed in a communication building, an ONU 92 is installed on the user side, both are connected by the optical fiber 95, and communication is made possible between the OLT 81 and the ONU 82 by using the optical fiber 95, whereby a service such as the Internet and telephone is provided.

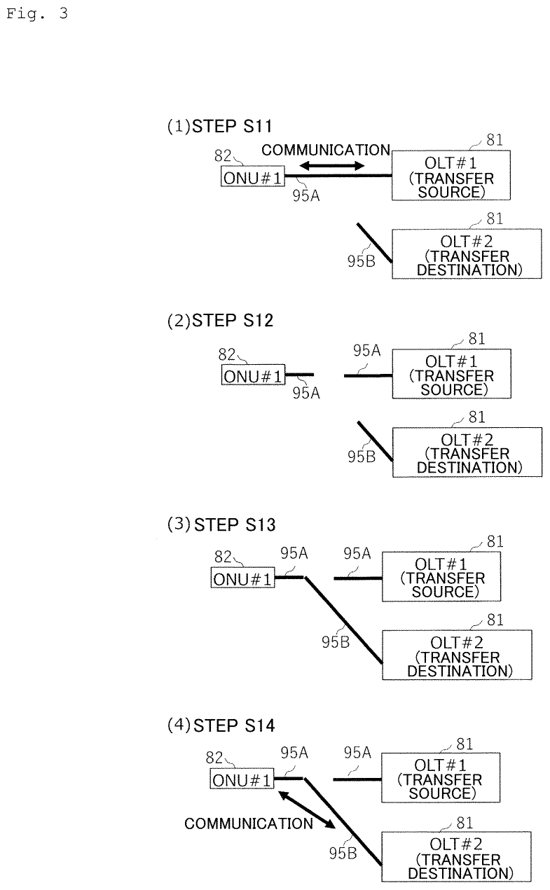

Communication buildings are built throughout the country, but some of them must be demolished due to aging. In order to demolish buildings, it is necessary to transfer the OLT 81 installed in the communication building to another building. The procedure is shown in FIG. 3. The OLT 81 installed in a building to be demolished is defined as an OLT 81 #1, and is defined as a transfer source. The splitter and IDM are omitted from the drawings. The OLT 81 #1 and an ONU 82 #1 perform communication by using an optical fiber 95A. Now, a switchover work for transferring from the OLT 81 #1 (transfer source) to the OLT 81 #2 (transfer destination) will be described.

First, the optical fiber 95A to be constructed is confirmed (step S11). In the present disclosure, the optical fiber 95A is referred to as a first optical fiber. When the confirmation is finished, the optical fiber 95A is cut (step S12). Then, the optical fiber 95A on the ONU 82 #1 side is connected to an optical fiber 95B extended from the transfer destination in advance (step S13). In the present disclosure, the optical fiber 95B is referred to as a second optical fiber. After the connection, it is confirmed that the communication between the OLT 81 #2 and the ONU 82 #1 is recovered, and the construction is completed (step S14).

Here, one optical fiber 95 included in the tape fiber 96 shown in FIG. 2 a is used for communication. Although the drawing of the connection destination of the other optical fibers 95 included in the tape fiber 96 is omitted, communication equipment is basically connected to both ends of the tape fiber 96. The steps S11 to S13 may be performed by the tape fiber 96 instead of the optical fiber 95.

A method for connecting the optical fibers 95A and 95B is described. Since the glass portion 93 is covered with the coating 94, the coating 94 of the optical fiber 95 provided in the optical fibers 95A and 95B is removed. When the coating 94 is removed, the glass portions 93 of the optical fibers 95A and 95B are exposed. In the present disclosure, for the optical fiber 95A, a part of the coating 94 in the middle in the longitudinal direction is removed, and for the optical fiber 95B, the coating 94 at the tip in the longitudinal direction is removed.

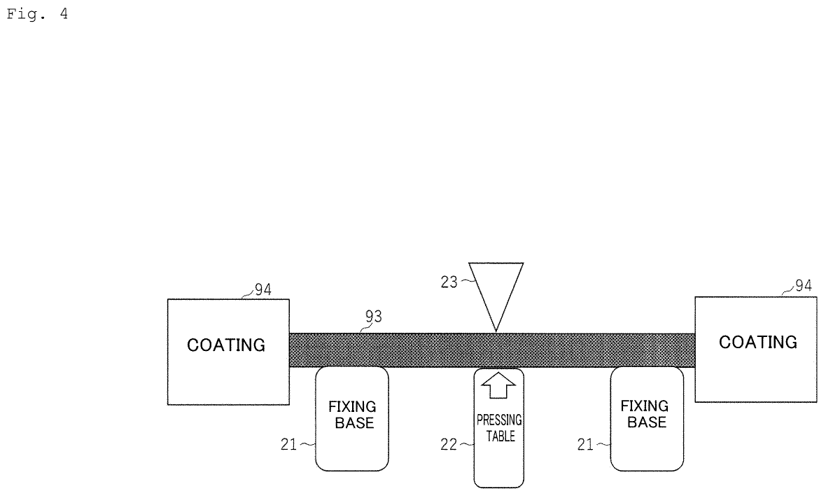

FIG. 4 shows an example of a method for cutting the optical fiber 95A in step S12. Both ends of the glass portion 93 of the optical fiber 95 are installed on a fixing base 21 in a state in which the glass portion 93 is made straight. When a pressing table 22 is moved upward from below, the glass portion 93 of the optical fiber 95 is sandwiched between a blade of a cutter 23 and the pressing table 22. By moving the blade of the cutter 23 toward, for example, the front side of the diagram, the blade of the cutter 23 is brought into contact with the glass portion 93, damaging the glass portion 93. Since the pressure is applied from the pressing table 22, the damaged glass portion 93 is cracked, resulting in cutting the optical fiber 95.

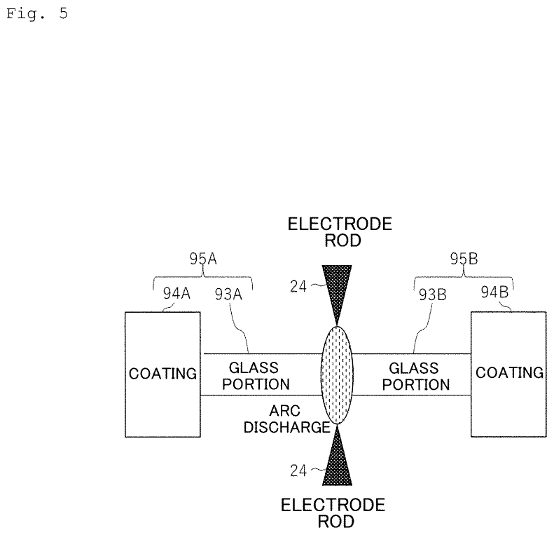

FIG. 5 shows an example of a method for connecting optical fibers in step S13. The optical fibers 95A and 95B are arranged in such a manner that an end face of a glass portion 93A of the cut optical fiber 95A and an end face of a glass portion 93B of the optical fiber 95B face each other, and the core glass 91 provided in the glass portions 93A and 93B is aligned with high accuracy. Thereafter, arc discharge is performed from an electrode rod 24, and ends of the glass portions 93A and 93B are melted to connect the end faces of the glass portions 93 to each other (see, for example, NPL 2).

It is ideal that the communication remain connected 24 hours 365 days. However, in steps S12 and S13, the optical fiber 95 is cut and fused, stopping the communication during that process. In the present disclosure, the amount of time communication stops due to cutting and fusion in steps S12 and S13 is shortened.

### Embodiment 1

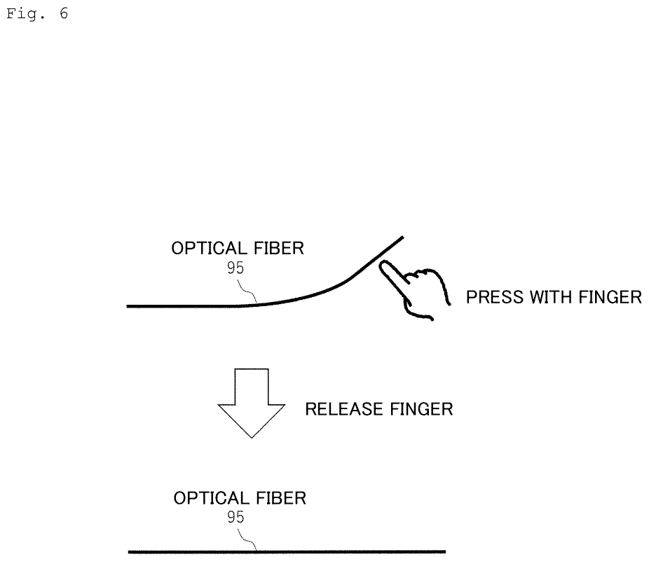

In Embodiment 1, the principle will be described by taking one optical fiber 95 shown in FIG. 2B as an example. The principle of focus is shown in FIG. 6. The diameter of a typical optical fiber 95 is approximately 250 μm. For comparison, the diameter of one strand of hair is approximately 100 μm, which is approximately the same as the diameter of the optical fiber 95, so it can be seen that the optical fiber 95 is very thin. Further, the optical fiber 95 has flexibility. This is because the optical fiber 95 is designed on the assumption that wiring is provided in a building or the like, and wiring needs to be provided in a small space, so the optical fiber 95 breaks if it is rigid. For this reason, the optical fiber 95 has flexibility. The optical fiber 95 can be bent, for example, by pushing it with a finger. When the pressing finger is released from the optical fiber 95, the optical fiber 95 returns to the original linear shape. The present disclosure uses this principle.

Specifically, in the present disclosure, in step S12 shown in FIG. 5,
the exposed glass portion 93A of the optical fiber 95A of the transfer source is bent,
the exposed glass portion 93B of the optical fiber 95B is arranged on a straight line when the exposed glass portion 93A of the optical fiber 95A is arranged linearly, in such a manner that the end face of the exposed glass portion 93B of the optical fiber 95B of the transfer destination faces the optical fiber 95A, and
by cutting the curved portion of the exposed glass portion 93A of the optical fiber 95A, the exposed glass portions 93A and 93B are arranged on said straight line.

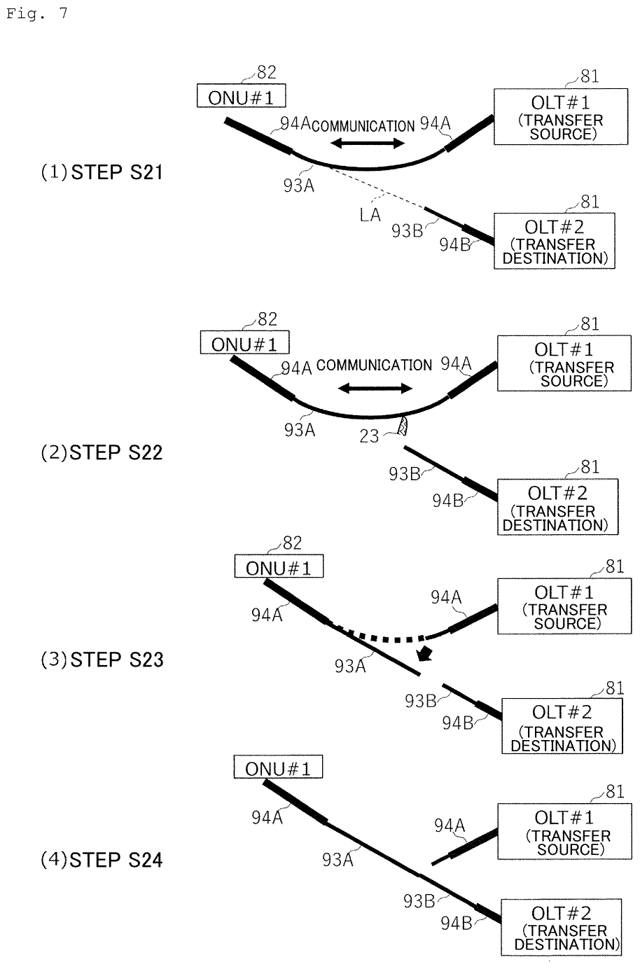

FIG. 7 shows an example of an optical fiber connection method of the present disclosure. First, a coating 94A of the optical fiber 95A is removed by using a conventional tool, the glass portion 93A is exposed, and the exposed glass portion 93A is bent (step S21). At this time, by making the bending of the glass portion 93A gentle, a loss due to the bending is suppressed, and the OLT 81 #1 and the ONU 82 #1 of the transfer source can maintain communication.

Further, a coating 94B at the tip of the optical fiber 95 extended from the OLT 81 #2 of the transfer destination is removed to expose the glass portion 93B. Then, the glass portion 93B is arranged on a straight line LA when the coating 94A of the optical fiber is made linear.

Next, the cutter 23 is brought into abutment with the curved portion of the glass portion 93A (step S22). Thus, the surface of the glass portion 93A is damaged. Since the glass portion 93A is curved, a crack spreads from the damage and the glass portion 93A can be cut. Thus, in the present embodiment, the glass portion 93A is cut by using the bending stress generated by bending the glass portion 93A, and the pressing table 22 shown in FIG. 4 is not required. Once the glass portion 93A is cut, the curved portion of the glass portion 93A is released at the same time as the cutting, and the glass portion 93A becomes linear from the curved state (step S23). At this time, the end face of the glass portion 93A and the end face of the glass portion 93B are arranged facing each other on the straight line LA.

In the present embodiment, in step S21, the glass portion 93B is arranged on the straight line LA. Therefore, the glass portion 93B of the optical fiber 95B extended from the OLT 81 #2 of the transfer destination is arranged at the tip of the linear glass portion 93A. Therefore, in the present embodiment, the glass portion 93A and the glass portion 93B can be easily connected (step S24).

After step S24, step S14 described above is executed. That is, it is confirmed that the communication between the OLT 81 #2 and the ONU 82 #1 is restored, and the construction is completed.

Although one optical fiber 95 shown in FIG. 2B is taken as an example in the above example, similar procedures can be executed even with the tape fiber 96 containing a plurality of optical fibers 95 as shown in FIG. 2A.

### Embodiment 2

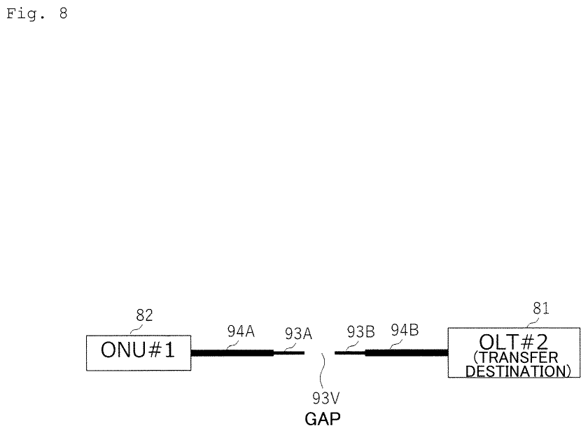

FIG. 8 is a diagram showing step S23 of FIG. 7 in detail. Since one optical fiber 95 has a very small diameter of 125 μm, positioning is difficult, and a gap 93V is easily formed between the glass portion 93A of the ONU 82 #1 and the glass portion 93B of the OLT 81 #2. When the distance of the gap 93V is large, the power loss of the communication light becomes large at the gap 93V, thereby disabling the communication. However, when the distance of the gap 93V is narrowed, the loss generated in the gap 93V can be reduced, thereby enabling the communication.

Therefore, in the present disclosure, when the glass portion 93B is arranged on the straight line LA in step S21, the glass portion 93B is arranged at a position where the gap 93V becomes small to the extent that communication is possible. Thus, communication can be started without fusing the glass portions 93A and 93B.

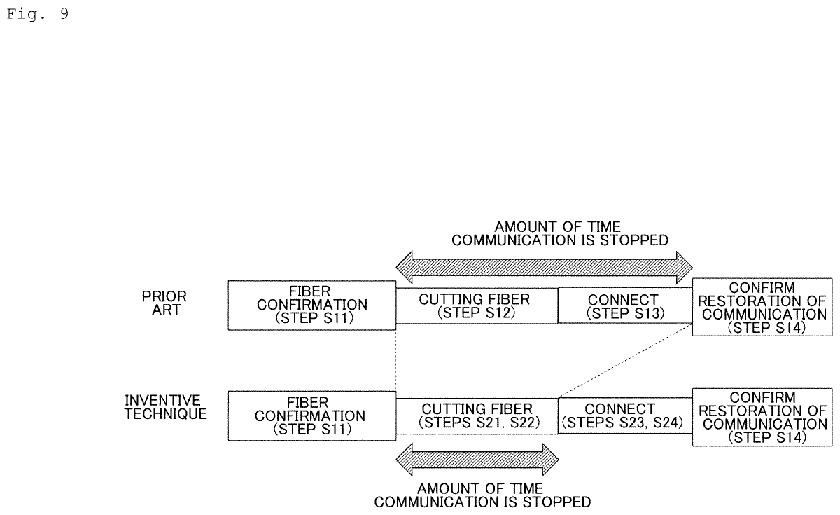

Conventionally, communication was started after the glass portions 93A and 93B were fused, but according to the present embodiment, communication can be started before fusion, achieving the effect of making the time for interrupting communication extremely short. The effect will be described with reference to FIG. 9 of Embodiment 3. Thereafter, the glass portions 93A and 93B are connected by means of fusion (step S24). At the time of fusion, the end faces of the optical fibers are melted and connected at a high temperature, but communication is not interrupted at that time. As described above, in the present embodiment, the communication can be started before the fusion splicing, and the communication can be maintained even during the fusion splicing after the start of the fusion splicing.

Although one optical fiber shown in FIG. 2B is taken as an example in the above example, the same procedures can be performed with a tape fiber containing four optical fibers as shown in FIG. 2A.

### Embodiment 3

In the present embodiment, a comparison between the prior art described with reference to FIG. 3 and the inventive technique of the present embodiment is shown in FIG. 9. In the prior art, there are four minutes of fiber confirmation (Sl1) as preparation, a total of 14 minutes are required: three minutes of fiber cutting (S12), three minutes of fusion splicing (S13), and four minutes of confirming communication restoration (S14). The communication is stopped by the fiber cutting (S12) and the fusion splicing (S13), totaling 6 minutes.

According to the present disclosure, the communication is stopped only by cutting the optical fiber 95A (S22). When the present disclosure is used, the time required for cutting the optical fiber 95A (S22) is three minutes, and the communication is stopped only for the three minutes. Although the communication is stopped for six minutes in the prior art, the technique of the present disclosure can shorten the amount of time communication stops to three minutes.

Further, as described in Embodiment 2, by reducing the gap 93V, communication can be started immediately after the glass portion 93A is damaged in the cutting of the optical fiber 95A (S22). Therefore, the present disclosure can make the amount of time communication stops extremely short in the switchover work for the optical fiber 95.

### Embodiment 4

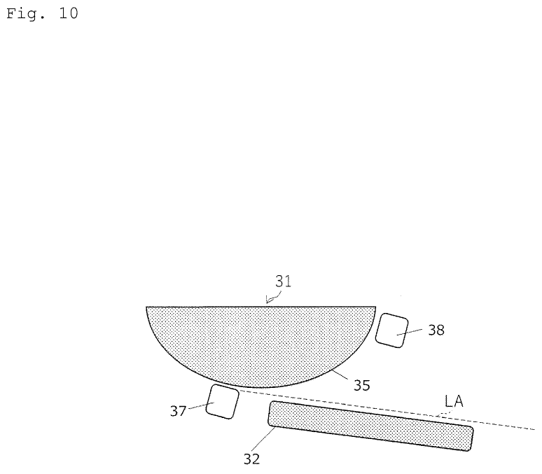

The present embodiment will describe a configuration of a device for realizing the optical fiber connection method of the present disclosure. FIG. 10 shows an example of a configuration of the optical fiber connection device of the present disclosure. The optical fiber connection device of the present disclosure is a device for connecting two optical fibers, and includes: a first holding member 31 for holding the glass portion 93A of the optical fiber 95A of the transfer source; a second holding member 32 for holding the glass portion 93B of the optical fiber 95B of the transfer destination; and pressing portions 37 and 38 for fixing the glass portion 93A on the first holding member 31. Although not shown in FIG. 10, the optical fiber connection device of the present disclosure further includes the cutter 23 and the electrode rod 24.

The first holding member 31 has a curved portion 35 for bending the glass portion 95A. The shape of the curved portion 35 is, for example, an arc shape. The second holding member 32 holds the glass portion 93B of the transfer destination on a straight line LA when the glass portion 93A held by the curved portion 35 is arranged substantially linearly.

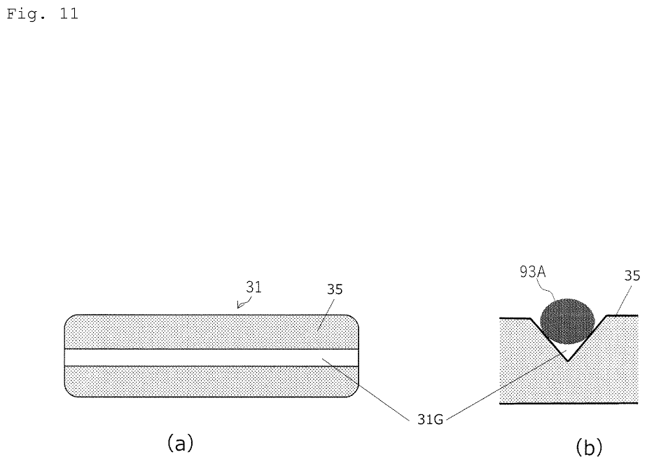

A V-groove 31G for holding the glass portion 93A is arranged in the curved portion 35 of the first holding member 31 as shown in FIG. 11. A V-groove similar to the V-groove 31G is also arranged in the holding portion of the glass portion 93B in the second holding member 32. In the present disclosure, since the glass portion 93A held in the V-groove 31G is cut by the cutter 23, the depth of the V-groove 31G from which the glass portion 93A protrudes is set as shown in FIG. 11(b).

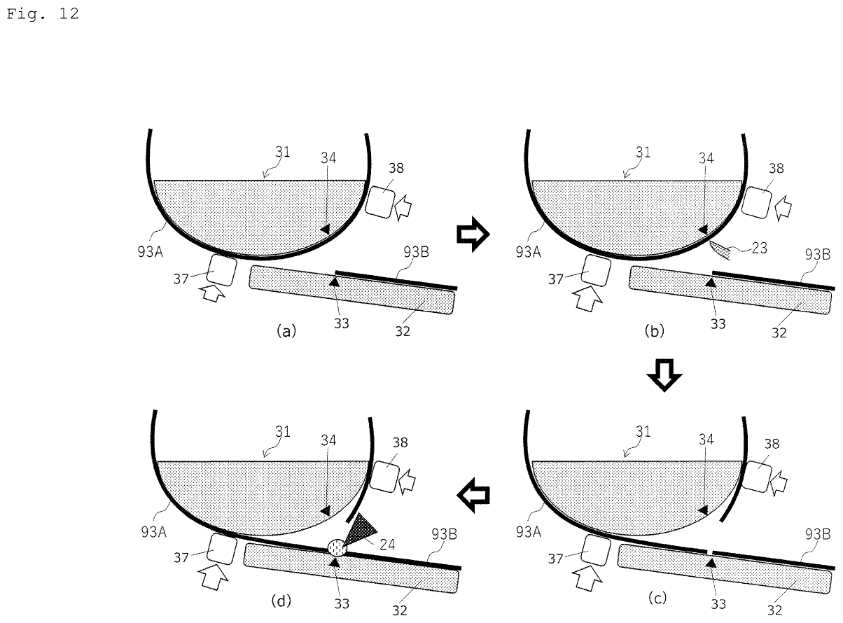

FIG. 12 shows an example of a method of using the optical fiber connection device of the present disclosure.

The glass portion 93A is arranged in the curved portion 35 of the first holding member 31, and an end of the glass portion 93B is arranged in the second holding member 32 (FIG. 12(a)). Here, the end of the glass portion 93B is arranged at a predetermined position 33. Next, the glass portion 93A is cut by the cutter 23 at a predetermined position 34 in the curved portion 35 of the first holding member 31 (FIG. 12 (b)).

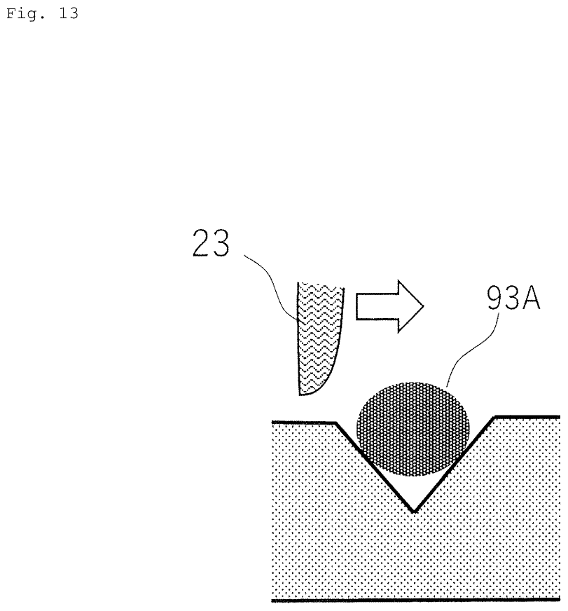

The position 34 is a position where the cut end of the glass portion 93A is arranged at the position 33 of the holding member 32 when the glass portion 93A is cut at the position 34. Therefore, the glass portion 93A is wound around the curved portion 35 of the first holding member 31 with no space therebetween, and the glass portion 93A is fixed to the curved portion 35 by the pressing portions 37 and 38. For example, both ends of the glass portion 93A can be pulled and bent. Alternatively, the glass portion 93A can be bent by moving the first holding member 31 to the glass portion 93A side. Further, the cutter 23 is also fixed in advance at the position 34, and it is preferable to adopt a configuration for damaging the surface of the glass portion 93A by sliding it at the position 34 as shown in FIG. 13.

In this manner, the end of the glass portion 93A cut by the cutter 23 is arranged at the position 33 (FIG. 12(c)). The ends of the glass portions 93A and 93B are held on the V-groove of the second holding member 32 so that the end face of the glass portion 93A and the end face of the glass portion 93B face each other on the straight line LA. Therefore, even when a gap is formed at the ends of the glass portions 93A and 93B, the optical fibers 95A and 95B can be aligned by pressing the glass portion 93B to the glass portion 93A side on the V-groove of the second holding member 32.

After the optical fibers 95A and 95B are aligned, arc discharge is performed from the electrode rod 24 on the position 33, and the ends of the glass portions 93A and 93B are melted to connect the end faces of the glass portions 93A and 93B.

In the present disclosure, fusions of the glass portions 93A and 93B is also performed at the predetermined position 33. Therefore, the electrode rod 24 is installed in advance at the position 33, and the glass portions 93A and 93B can be fused.

Although only the glass portions 93A and 93B are described in FIG. 12 so as to be easily understood, only the glass portions 93A and 93B may be exposed for the portions to be cut and fused, and in the diagram, a coating may remain on the portions which are not cut and fused. For example, the pressing portions 37 and 38 may press either the glass portion or the coating of the optical fiber 95A.

The position at which the second holding member 32 holds the glass portion 93B is not limited to a straight line where the glass portion 93A held by the curved portion 35 is arranged substantially linearly, and is not limited to such a structure as long as the end of the glass portion 93A obtained after cutting can be held by the second holding member 32 by the elasticity of the glass portion 93A.

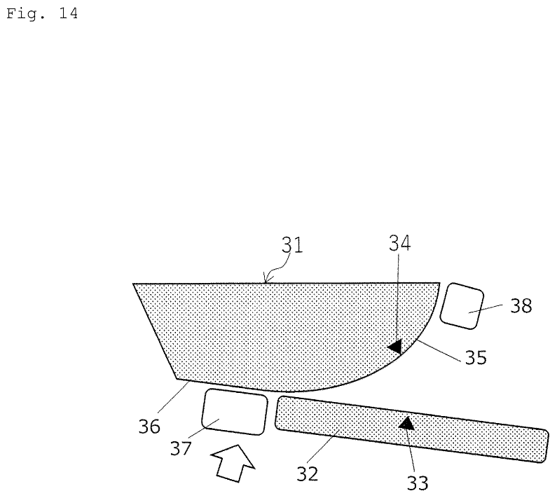

Further, as shown in FIG. 14, a straight line portion 36 may be arranged together with the curved portion 35 on the surface of the first holding member 31 where the V-groove 31G is arranged. In this case, the glass portion 93B held by the second holding member 32 is arranged on a straight line that is formed by the glass portion 93A by linearly arranging the glass portion 93A on the straight line portion 36.

### REFERENCE SIGNS LIST

21 Fixed base
22 Pressing table
23 Cutter
24 Electrode rod
31 First holding member
32 Second holding member
35 Curved portion
36 Straight line portion
37, 38 Pressing portion
81 OLT
82 ONU
83 IDM
84 Optical cable
85 Optical splitter
91 Core glass
92 Cladding glass
93, 93A, 93B Glass portion
94, 94A, 94B Coating
95 Optical fiber
96 Tape fiber

1. A device for connecting two optical fibers, the device being configured to:
fix one end of an exposed cladding of a first optical fiber in which a part of a cladding in a longitudinal direction is exposed;
bend the exposed cladding of the first optical fiber;
arrange an exposed cladding of a second optical fiber on a straight line when the exposed cladding of the first optical fiber is arranged linearly, in such a manner that an end face of the exposed cladding of the second optical fiber faces the first optical fiber;
cut the curved portion of the first optical fiber to arrange the first optical fiber and the second optical fiber on the straight line; and
connect an end face of the exposed cladding of the first optical fiber and the end face of the exposed cladding of the second optical fiber.

2. The device according to claim 1, wherein the claddings are made of glass, and
the curved portion of the first optical fiber is cut and at the same time released to be linear by damaging a surface of the exposed cladding of the first optical fiber, and
the end face of the exposed cladding of the first optical fiber and the end face of the exposed cladding of the second optical fiber are arranged so as to face each other on the straight line.

3. A method for connecting two optical fibers, the method comprising:
exposing a part of a cladding in a longitudinal direction of a first optical fiber;
exposing a cladding of a tip of a second optical fiber;
bending the exposed cladding of the first optical fiber;
arranging an exposed cladding of the second optical fiber on a straight line when the exposed cladding of the first optical fiber is arranged linearly, in such a manner that an end face of the exposed cladding of the second optical fiber faces the first optical fiber;
cutting the curved portion of the first optical fiber to arrange the exposed claddings of the first optical fiber and the second optical fiber on the straight line; and
connecting an end face of the exposed cladding of the first optical fiber and the end face of the exposed cladding of the second optical fiber.

4. The method according to claim 3, wherein the exposed cladding of the second optical fiber is arranged in such a manner that a distance between a position on the straight line where the first optical fiber is cut and a position on the straight line where the end face of the exposed cladding of the second optical fiber is arranged becomes small when the exposed cladding of the second optical fiber is arranged.

5. The method according to claim 3, wherein the claddings are made of glass, and
after the curved portion of the first optical fiber is cut to arrange the first optical fiber and the second optical fiber on the straight line, and before fusion splicing of the end face of the cladding of the first optical fiber and the end face of the cladding of the second optical fiber is performed, communication is started.

6. The method according to claim 5, wherein after the fusion splicing is started, communication is maintained during the fusion splicing.
